(19) United States
(12) Patent Application Publication
(10) Pub. No.: US 2026/0120485 A1
(43) Pub. Date: Apr. 30, 2026

(54) DISPLAY DEVICE AND METHOD FOR PROCESSING IMAGE INCLUDING OBJECT OF INTEREST

(71) Applicant: SAMSUNG ELECTRONICS CO., LTD., Suwon-si (KR)

(72) Inventor: Youngho LEE, Suwon-si (KR)

(73) Assignee: SAMSUNG ELECTRONICS CO., LTD., Suwon-si (KR)

(21) Appl. No.: 19/395,914

(22) Filed: Nov. 20, 2025

Related U.S. Application Data
(63) Continuation of application No. PCT/KR2025/017202, filed on Oct. 27, 2025.

(30) Foreign Application Priority Data
Oct. 31, 2024 (KR) 10-2024-0152125

(51) Int. Cl. G06V 20/64; G06V 10/25; G06V 10/74

(52) U.S. Cl. CPC G06V 20/64; G06V 10/25; G06V 10/761; G06V 2201/07

(57) ABSTRACT

A display device configured to: detect an object of interest in a first frame of an image; obtain motion information representing a motion between the first frame and a second frame based on a shape of the object of interest; and add a motion compensation frame based on the motion information, wherein to obtain the motion information, the display device is further configured to: set a plurality of weights including a first weight associated with a region of interest corresponding to the object of interest, and a second weight associated with a background region, wherein the plurality of weights are used to select a matching block that matches a reference block including the object of interest, from among a plurality of candidate search blocks of the second frame, and wherein the reference block and the matching block are used to obtain the motion information.

### CROSS-REFERENCE TO RELATED APPLICATIONS

This application is a continuation of International Application No. PCT/KR2025/017202 designating the United States, filed on Oct. 27, 2025, in the Korean Intellectual Property Receiving Office and claiming priority to Korean Patent Application No. 10-2024-0152125, filed on Oct. 31, 2024, in the Korean Intellectual Property Office, the disclosures of each of which are incorporated by reference herein in their entireties.

### TECHNICAL FIELD

The disclosure relates to a display device and method for processing an image including an object of interest.

### BACKGROUND ART

When viewing a video, the viewer may focus attention on a specific object. For example, when watching a video of a sports game, the viewer may focus attention on the motion of a specific object such as a ball.

Accurately estimating the motion of an object of interest on which attention is focused may help to provide a natural image to the viewer. For example, through accurate motion estimation of the object of interest between consecutive frames, accurate motion compensation may be performed. Accordingly, an image including a moving object of interest which moves more smoothly may be provided to the viewer.

The above-described information may be provided as related art for the purpose of helping understanding of the disclosure. The foregoing cannot be claimed as, or used to determine, the prior art related to the disclosure.

### DISCLOSURE OF INVENTION

### Solution to Problems

In accordance with an aspect of the disclosure, a display device includes: a display; at least one processor including processing circuitry; and memory including at least one storage medium storing one or more instructions which, when executed by the at least one processor, cause the display device to: detect an object of interest included in a first frame of an image; obtain motion information representing a motion of the object of interest between the first frame and a second frame based on a shape of the object of interest; and add a motion compensation frame between the first frame and the second frame based on the motion information, wherein to obtain the motion information, the one or more instructions, when executed by the at least one processor, may further cause the display device to: set a plurality of weights including a first weight associated with a region of interest corresponding to the object of interest, and a second weight associated with a background region different from the region of interest, wherein the second weight is different from the first weight, and wherein the plurality of weights are used to select a matching block that matches a reference block including the object of interest, from among a plurality of candidate search blocks of the second frame, and wherein the reference block and the matching block are used to obtain the motion information.

To set the plurality of weights, the one or more instructions, when executed by the at least one processor, may further cause the display device to: set a first weight value for a first plurality of pixels included in the region of interest, and set a second weight value for a second plurality of pixels included in the background region, and the first weight value may be larger than the second weight value.

To obtain the motion information, the one or more instructions, when executed by the at least one processor, may further cause the display device to: select the matching block using a block matching algorithm according to a specified similarity measurement scheme; and obtain the motion information based on the reference block and the matching block.

To select the matching block, the one or more instructions, when executed by the at least one processor, may further cause the display device to: measure a similarity between the reference block and each candidate search block from among the plurality of candidate search blocks using the specified similarity measurement scheme based on the first weight and the second weight value.

The specified similarity measurement scheme may correspond to a sum of squared differences (SAD) scheme, and the SAD scheme may be performed according to a following equation:

$$SAD ( k ) = {\sum }_{i = 0}^{m - 1} {\sum }_{j = 0}^{n - 1} wgt ( i , j ) * \vert Pre ( i , j ) - Cur ( i , j ) \vert$$

where Pre(i,j) may denote a pixel value corresponding to a position (i,j) in the reference block of the first frame, Cur(i,j) may denote a pixel value corresponding to the position (i,j) in a candidate search block from among the plurality of candidate search blocks, wgt(i,j) may denote a weight value of a pixel corresponding to the position (i,j), m may denote a vertical size of the candidate search block, n may denote a horizontal size of the candidate search block, and k may denote an index of the candidate search block.

To identify the shape of the object of interest, the one or more instructions, when executed by the at least one processor, may further cause the display device to: obtain information about the shape of the object of interest using a trained artificial intelligence model, and the trained artificial intelligence model may be trained to output output data including information about the shape of the object of interest based on an input frame.

The output data may further include object-of-interest detection information, and the object-of-interest detection information may include at least one of type information about a type of the object of interest, sub type information about a sub type of the object of interest, or confidence information about a confidence level associated with the object of interest.

To identify the shape of the object of interest, the one or more instructions, when executed by the at least one processor, may further cause the display device to: sub-sample the image at a predetermined ratio such that the object of interest is included in one block.

The first frame may be consecutive with the second frame, the motion information may correspond to a motion vector for the object of interest, and the motion compensation frame may be generated based on the motion vector.

The motion compensation frame may be used to perform at least one from among frame rate conversion, motion compensated interpolation, or motion judder cancellation.

In accordance with an aspect of the disclosure, a method of controlling a display device includes: detecting an object of interest included in a first frame of an image; obtaining motion information representing a motion of the object of interest between the first frame and a second frame based on a shape of the object of interest; and adding a motion compensation frame between the first frame and the second frame based on the motion information, wherein the obtaining of the motion information includes: setting a plurality of weights including a first weight associated with a region of interest corresponding to the object of interest, and a second weight associated with a background region other than the region of interest, wherein the second weight is different from the first weight, wherein the plurality of weights are used to select a matching block that matches a reference block including the object of interest, from among a plurality of candidate search blocks of the second frame, and wherein the reference block and the matching block are used to obtain the motion information.

The setting of the plurality of weights may include: setting a first weight value for a first plurality of pixels included in the region of interest, and setting a second weight value for a second plurality of pixels included in the background region, and the first weight value may be larger than the second weight value.

The obtaining of the motion information may include: selecting the matching block using a block matching algorithm according to a specified similarity measurement scheme; and obtaining the motion information based on the reference block and the matching block.

The selecting of the matching block may include: measuring a similarity between the reference block and each candidate search block from among the plurality of candidate search blocks using the specified similarity measurement scheme based on the first weight value and the second weight value.

The specified similarity measurement scheme may correspond to a sum of squared differences (SAD) scheme, and the SAD scheme may be performed using a following equation:

$$SAD ( k ) = {\sum }_{i = 0}^{m - 1} {\sum }_{j = 0}^{n - 1} wgt ( i , j ) * \vert Pre ( i , j ) - Cur ( i , j ) \vert$$

where Pre(i,j) may denote a pixel value corresponding to a position (i,j) in the reference block of the first frame, Cur(i,j) may denote a pixel value corresponding to the position (i,j) in the candidate search block from among the plurality of candidate search blocks, wgt(i,j) may denote a weight value of a pixel corresponding to the position (i,j), m may denote a vertical size of the candidate search block, n may denote a horizontal size of the candidate search block, and k may denote an index of the candidate search block.

Identifying the shape of the object of interest may include: obtaining information about the shape of the object of interest using a trained artificial intelligence model, and wherein the trained artificial intelligence model may be trained to output output data including information about the shape of the object of interest based on an input frame.

The output data may further include object-of-interest detection information, and the object-of-interest detection information may include at least one of type information about a type of the object of interest, sub type information about a sub type of the object of interest, or confidence information about a confidence level associated with the object of interest.

The identifying of the shape of the object of interest may include: sub-sampling the image at a predetermined ratio such that the object of interest is included in one block.

The first frame may be consecutive with the second frame, the motion information may correspond to a motion vector for the object of interest, and the motion compensation frame may be generated based on the motion vector.

The motion compensation frame may be used to perform at least one from among frame rate conversion, motion compensated interpolation, or motion judder cancellation.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating a configuration of a display device according to an embodiment of the disclosure.

FIG. 2 is a view illustrating an image including an object of interest according to an embodiment of the disclosure.

FIG. 3 is a view illustrating a configuration of a display device for performing an operation of estimating a motion of an object of interest according to an embodiment of the disclosure.

FIG. 4A is a view illustrating a motion of an object of interest in a consecutive frame including the object of interest according to an embodiment of the disclosure.

FIG. 4B is a view illustrating a region of interest corresponding to an object of interest and a background region according to an embodiment of the disclosure.

FIG. 5 is a flowchart illustrating an operation of estimating a motion of an object of interest by a display device according to an embodiment of the disclosure.

FIGS. 6A to 6C are views illustrating a configuration of a display device for performing an operation of estimating a motion of an object of interest according to an embodiment of the disclosure.

FIG. 7A is a view illustrating an artificial intelligence model used to detect an object of interest and/or a shape of the object of interest according to an embodiment of the disclosure.

FIG. 7B is a view illustrating output data obtained through the artificial intelligence model of FIG. 7A according to an embodiment of the disclosure.

FIG. 8 is a view illustrating an operation of setting different weights for a region of interest corresponding to an object of interest and a background region, according to an embodiment of the disclosure.

FIG. 9 is a view illustrating an operation of sub-sampling an image including an object of interest by a display device according to an embodiment of the disclosure.

FIG. 10 is a view illustrating an operation of performing motion compensation based on motion information by a display device according to an embodiment of the disclosure.

### MODE FOR THE INVENTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

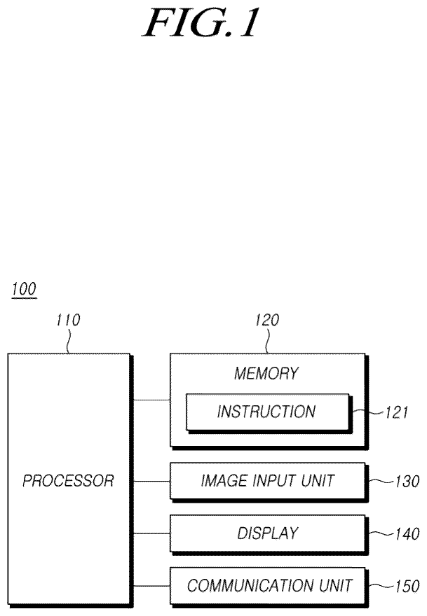

According to embodiments, the same or similar reference numerals may be used to refer to the same or similar elements throughout the disclosure. FIG. 1 is a view illustrating a configuration of a display device according to an embodiment of the disclosure.

According to an embodiment, the display device 100 may be, but is not limited to, a smartphone, a personal computer (PC), a tablet PC, a smart TV, a mobile phone, a personal digital assistant (PDA), a laptop computer, a media player, a micro server, a digital broadcast terminal, a navigation, a kiosk, a home appliance, or other mobile or non-mobile computing devices. The display device 100 may perform various computing functions, such as real-time video viewing and communication. In the following description, it is assumed that the display device 100 is a TV or a monitor, but this is merely an example and embodiments of the disclosure may be equally applied to electronic devices having a display function.

Referring to FIG. 1, the display device 100 may include at least one processor 110, memory 120, an image input unit 130, a display 140, and a communication unit 150.

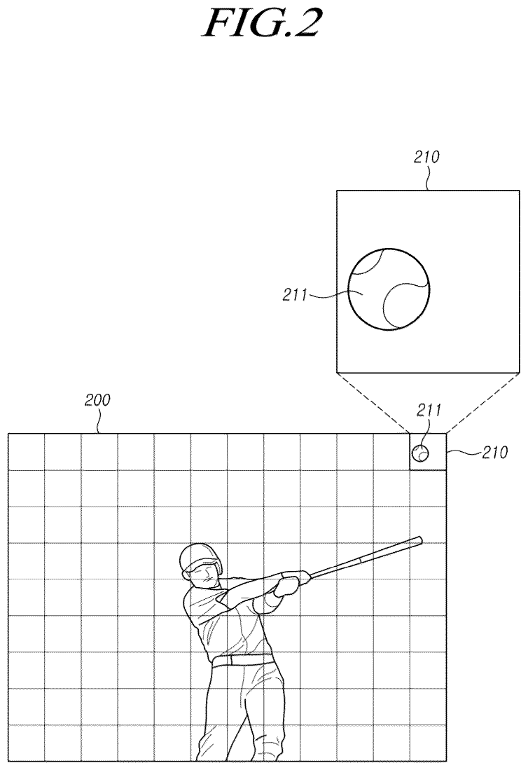

According to an embodiment, the memory 120 is a storage medium used by the display device 100 and may store data, such as one or more instructions 121 (e.g., one or more commands) or configuration information corresponding to at least one program. The program may include an operating system (OS) program and various application programs. The instructions 121 stored in the memory 120 may, when executed by at least one processor 110, cause the display device 100 to perform at least one operation (e.g., at least one of the operations described below with reference to FIGS. 2 to 10).

According to an embodiment, the memory 120 may include at least one type of storage medium of flash memory types, hard disk types, multimedia card micro types, card types of memories (e.g., secure digital (SD) or extreme digital (XD) memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the image input unit 130 may receive image data through (e.g., using) at least one of a tuner, an input/output unit, or the communication unit 150. The image input unit 130 may include at least one of the tuner and the input/output unit. The tuner may tune and select only the frequency of the broadcast channel to be received by the display device 100 among many radio components, by amplifying, mixing, and resonating the broadcast signals wiredly/wirelessly received. The broadcast signal may include video, audio, and additional data (e.g., electronic program guide (EPG)). The tuner may receive broadcast channels (or viewing images) from various broadcast sources, such as terrestrial broadcasts, cable broadcasts, satellite broadcasts, Internet broadcasts, and the like. The tuner may be implemented integrally with the display device 100 or may be implemented as a separate tuner electrically connected to the display device 100. The input/output unit may include at least one of a high definition multimedia interface (HDMI) input port, a component input jack, a PC input port, or a USB input jack capable of receiving image data from an external device of the display device 100 under the control of the processor 110. It is obvious to one of ordinary skill in the art that the input/output unit may be added, deleted, and/or changed according to the performance and structure of the display device 100.

According to an embodiment, the display 140 may perform functions for outputting information in the form of numbers, characters, images, and/or graphics. The display 140 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 140 may display a screen corresponding to data received from the processor 110. The display 140 may be referred to as an output unit, a display unit, or by other terms having an equivalent technical meaning.

According to an embodiment, the communication unit 150 may include a communication circuitry and provide a wired/wireless communication interface that enables communication with an external device. The communication unit 150 may include at least one of a wired Ethernet, a wireless local area network (LAN) communication unit, and a short-range communication unit. The wireless LAN communication unit may include, e.g., Wi-Fi, and may support the wireless LAN standard (IEEE802.11x) of the Institute of Electrical and Electronics Engineers (IEEE). The wireless LAN communication unit may be wirelessly connected to an access point (AP) under the control of the processor 110. The short-range communication unit may perform short-range communication wirelessly with an external device under the control of the processor 110. Short-range communication may include Bluetooth, Bluetooth low energy (BLE), infrared data association (IrDA), ultra-wideband (UWB), Wi-Fi Direct, and near-field communication (NFC). The external device may include a server device and a mobile terminal (e.g., phone, tablet, etc.) providing, e.g., an image service.

According to an embodiment, the at least one processor 110 may control at least one other component of the display device 100 and/or execute computation or data processing regarding communication by executing one or more instructions 121 stored in the memory 120. The processor 110 may include at least one processing circuitry that executes instructions stored in the memory 120.

According to an embodiment, the at least one processor 110 may include various processing circuits and/or multiple processors. One or more of the at least one processor 110 may be configured to individually and/or collectively perform various functions described in the disclosure. As used herein, when it is described that “processor”, “at least one processor”, and “one or more processors” are configured to perform various functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 110 may include, e.g., a combination of processors performing various functions cited/initiated in a distributed manner. The at least one processor 110 may execute program instructions to achieve or perform various functions.

According to an embodiment, the at least one processor 110 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

According to an embodiment, the at least one processor 110 may execute, e.g., software to control at least one other component (e.g., a hardware or software component) of the display device 100 connected with the processor 110 and may process or compute various data. According to an embodiment, as at least part of the data processing or computation, the processor 110 may store a command or data received from another component onto a volatile memory, process the command or the data stored in the volatile memory, and store resulting data in a non-volatile memory. According to an embodiment, the processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, a main processor. For example, when the display device 100 includes the main processor and the auxiliary processor, the auxiliary processor may be configured to use less power than the main processor, or to perform a designated function. The auxiliary processor may be implemented separately from, or as part, of the main processor.

According to an embodiment, the processor 110 may obtain image frame data from at least one of the memory 120, the image input unit 130, or the communication unit 150. The processor may receive image frame data from at least one of the memory 120, the display 140, the image input unit 130, or the communication unit 150. The image frame data may include data regarding a frame included in an image. According to embodiments, the image may be a video, and the frame may be a frame included in the video. For example, the image frame data may be obtained from the memory 120 (e.g., an image that was previously recorded and stored). For example, the image frame data may include data obtained from the communication unit 150 or the image input unit 130 (e.g., real-time streaming image).

FIG. 2 is a view illustrating an image including an object of interest according to an embodiment of the disclosure.

Referring to FIG. 2, an image 200 (or a frame of an image) may include at least one object of interest 211. According to embodiments, when the object of interest 211 is described as being included in the image 200 or the frame of the image 200, this may mean that an image portion corresponding to the object of interest 211 is included in the image 200 or the frame of the image 200. For example, this may mean that a representation or a depiction of the object of interest is included in the image 200 or the frame of the image 200. According to embodiments, the frame may also be referred to as an image frame.

According to an embodiment, the object of interest 211 may be an object that is a subject an interest of a viewer. For example, the object of interest 211 may be an object in the image 200 in which the viewer, who views the image 200, has an interest. The object of interest 211 may be associated with the content of the image 200. For example, as illustrated in FIG. 2, based on the image 200 being a video having the content of a sports game such as a baseball game, the viewer of the video (e.g., the viewer of the image 200) may focus attention on the motion of the ball used in the sports game. As a result, the object of interest 211 may be the ball (e.g., a baseball) used in the sports game.

According to an embodiment, the display device (e.g., the display device 100 of FIG. 1) may set the object of interest 211 of the image 200 based on the content of the image 200. For example, the display device 100 may analyze the content of the image 200 (e.g., analyze the type of content) and set at least one of the objects included in the image 200 as the object of interest 211 according to the analysis result (e.g., according to a result of the analyzing).

According to an embodiment, the display device (e.g., the display device 100 of FIG. 1) may set the object of interest 211 of the image 200 based on a specified setting. The specified setting may include, e.g., a setting based on at least one of a user input, signaling information included in the image 200, or a setting based on the metadata of the image 200, but embodiments are not limited thereto. The signaling information included in the image 200 is, e.g., information provided together with, or separately from, the image 200 by the device (e.g., a content provider) that transmits the image 200 to the display device 100, and may include information about the object of interest 211 in the image 200. The information about the object of interest 211 may include, e.g., the type (e.g., ball) of the object of interest, the sub type (e.g., baseball) of the object of interest, the shape (e.g., circular, elliptical) of the object of interest, the size of the object of interest 211, and/or other information related to the object of interest 211.

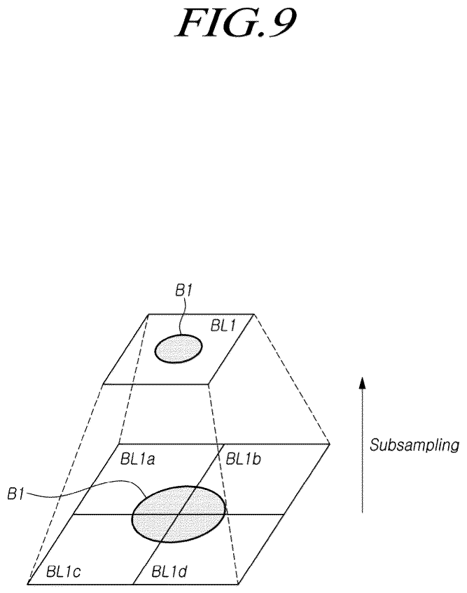

According to an embodiment, the object of interest 211 may be included in at least one block 210 in the frame of the image 200. For example, as illustrated in FIG. 2, the frame of the image 200 may be partitioned into blocks having a specified size (e.g., 8×8 or 16×16 size), and the object of interest 211 may be included in one block 210. On the other hand, based on the object of interest 211 being included in a plurality of blocks, the display device 100 may perform processing (e.g., sub-sampling) so that the object of interest 211 is included in one block 210 to accurately estimate the motion of the object of interest 211. An example of operation of sub-sampling the image 200 so that the object of interest 211 included in the plurality of blocks is included in one block 210 is described below with reference to FIG. 9.

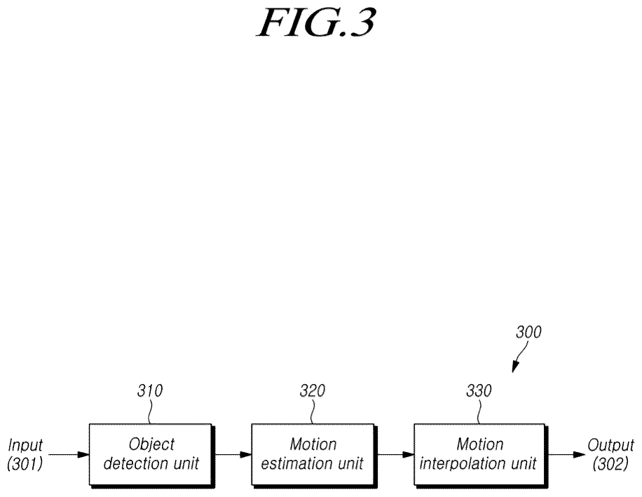

Hereinafter, an example of an operation of estimating the motion of the object of interest 211 is described with reference to FIG. 3. In the following description, for convenience of description, an example is described in which the object of interest 211 is a ball, but embodiments are not limited thereto. For example, various types of objects of interest 211 having motion characteristics (e.g., racing cars in racing broadcast images) may be applied to various embodiments of the disclosure.

FIG. 3 is a view illustrating a configuration of a display device for performing an operation of estimating a motion of an object of interest according to an embodiment of the disclosure.

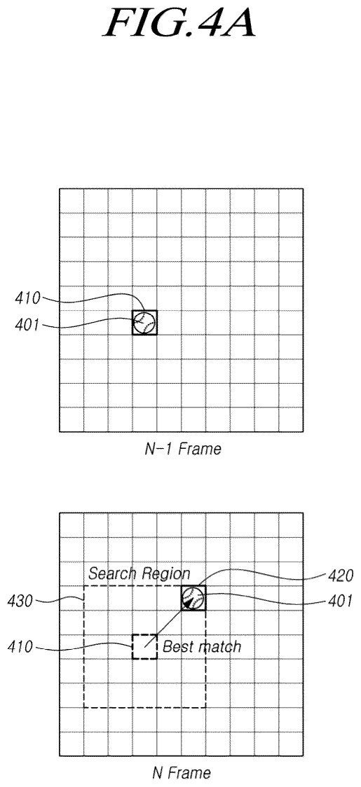

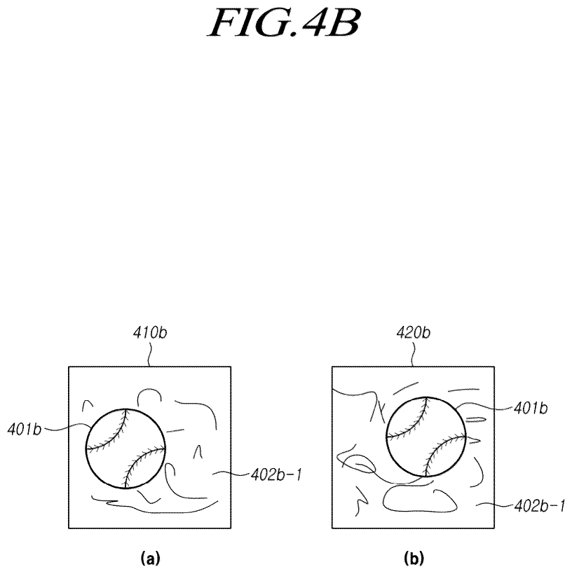

FIG. 4A is a view illustrating a motion of an object of interest in a consecutive frame including the object of interest according to an embodiment of the disclosure.

FIG. 4B is a view illustrating a region of interest corresponding to an object of interest and a background region according to an embodiment of the disclosure.

Referring to FIGS. 3 to 4B, a display device 300 (which may correspond to, for example, the display device 100 of FIG. 1) may include an object detection unit 310, a motion estimation unit 320, and/or a motion interpolation unit 330. According to an embodiment, some of the above-described components (e.g., the motion interpolation unit 330) may be omitted, and additional components may be further included.

According to an embodiment, the object detection unit 310, the motion estimation unit 320, and/or the motion interpolation unit 330 may be implemented using at least one processor (e.g., the processor 110 of FIG. 1). For example, instructions may be stored in memory (e.g., the memory 120 of FIG. 1) and, when executed by at least one processor 110, cause the display device 300 to perform at least one function and/or operation of the object detection unit 310, motion estimation unit 320, and/or motion interpolation unit 330.

According to an embodiment, the object detection unit 310 may receive input data 301 including at least one frame and detect an object of interest (e.g., the object of interest 211 of FIG. 2) included in each frame using a specified object detection algorithm. For example, as illustrated in FIG. 4A, the object detection unit 310 may receive a first frame (illustrated as “N−1 frame”) and detect an object of interest 401 (e.g., a baseball) included in the first block 410 of the first frame. For example, as illustrated in FIG. 4A, the object detection unit 310 may receive a second frame (illustrated as “N frame”) and detect the object of interest 401 included in the second block 420 of the second frame. The first frame and the second frame may be consecutive frames. The object detection unit 310 may transfer the data of the detected object of interest 401 to the motion estimation unit 320. The data of the object of interest 401 may include, e.g., location information of the object of interest 401. The location information of the object of interest 401 may include, e.g., the location coordinates of a block 410 and a block 420 including the object of interest 401 in the frame including the object of interest 401.

According to an embodiment, the motion estimation unit 320 may obtain motion information (e.g., motion vector) by receiving data (e.g., location information of the object of interest 401) from the object detection unit 310 and estimating the motion of the object of interest 401 between consecutive frames. The motion estimation unit 320 may obtain motion information about the object of interest 401 using a fixed block matching algorithm. The fixed block matching algorithm may be a block matching algorithm that uses a block having a predetermined size and shape without considering the shape of the object of interest 401. For example, based on the object of interest 401 being moved from the location of the first block 410 to the location of the second block 420 between the first frame and the second frame, as illustrated in FIG. 4A, the motion estimation unit 320 may determine (e.g., select) the second block 420 as the matching block of the first block 410 using the fixed block matching algorithm and obtain a motion vector for the object of interest 401 based on the first block 410 and the second block 420.

According to an embodiment, the motion interpolation unit 330 may interpolate the image based on the motion information. For example, the motion interpolation unit 330 may interpolate the image by performing motion compensation based on the motion information.

As described above, the motion estimation unit 320 of FIG. 3 may perform motion estimation on the object of interest 401 using the fixed block matching algorithm that always uses blocks of a predetermined size and shape, without considering the shape of the object of interest 401. Therefore, accurate motion estimation may be difficult in certain environments or situations. For example, in the example of block 410 and the example of block 420 shown in FIG. 4B, based on the complexity of the background region 402b-1 and the background region 402b-2 other than the region of interest corresponding to the object of interest 401b being relatively high, or the form in which the object of interest 401b is captured by the camera being changed, it may become difficult to accurately estimate the motion of the object of interest 401b. Therefore, in order to accurately estimate the location of the object of interest 401b, a motion estimation scheme may be used to reduce the influence of the background regions 402b-1, 402b-2 considering the shape of the object of interest 401b.

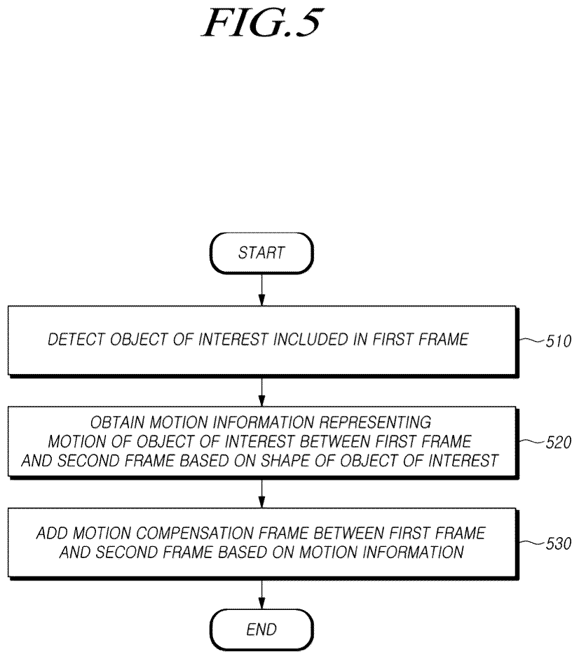

Hereinafter, an example of a method for performing motion estimation considering the shape of the object of interest is described with reference to FIGS. 5 to 10.

FIG. 5 is a flowchart illustrating an operation of estimating a motion of an object of interest by a display device according to an embodiment of the disclosure.

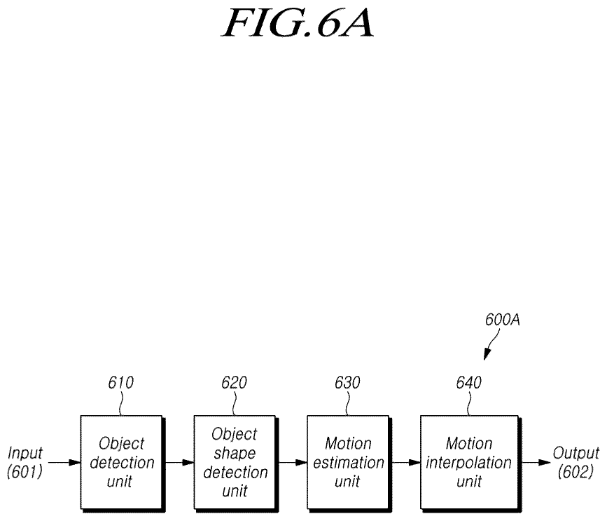

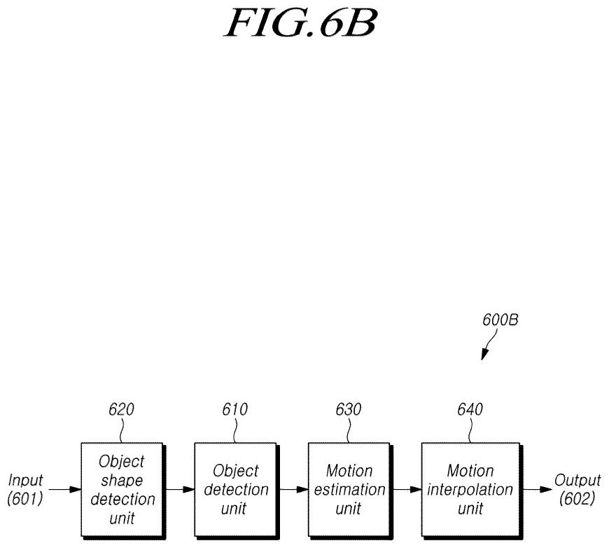

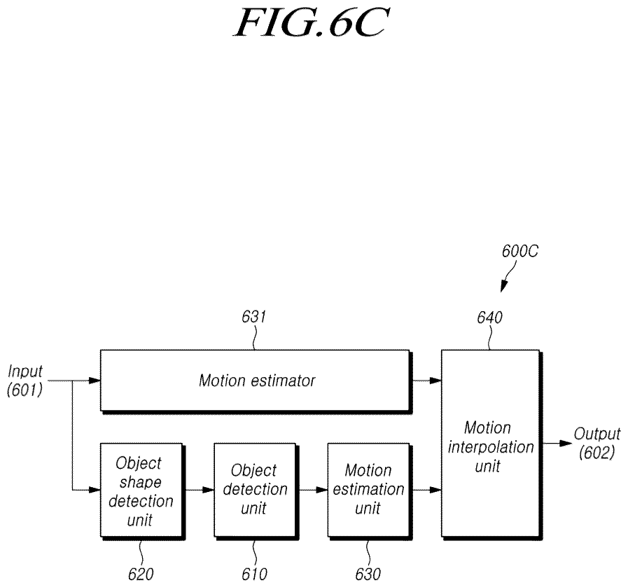

FIGS. 6A to 6C are views illustrating a configuration of a display device for performing an operation of estimating a motion of an object of interest according to an embodiment of the disclosure.

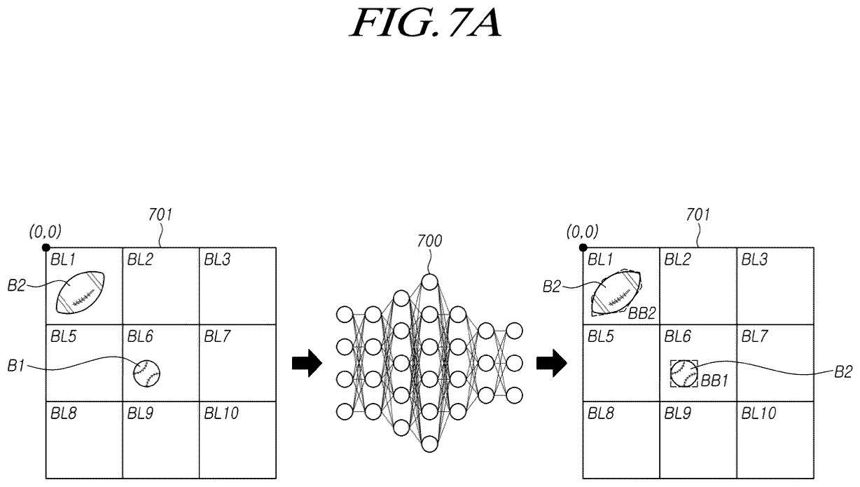

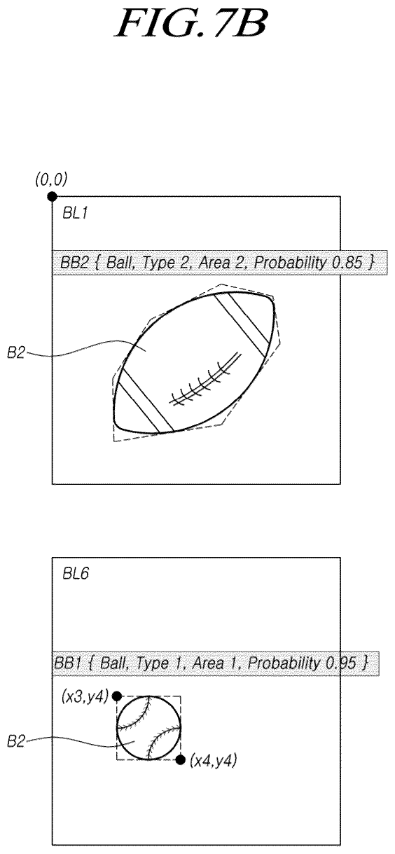

FIG. 7A is a view illustrating an artificial intelligence model used to detect an object of interest and/or a shape of the object of interest according to an embodiment of the disclosure.

FIG. 7B is a view illustrating output data obtained through the artificial intelligence model of FIG. 7A according to an embodiment of the disclosure.

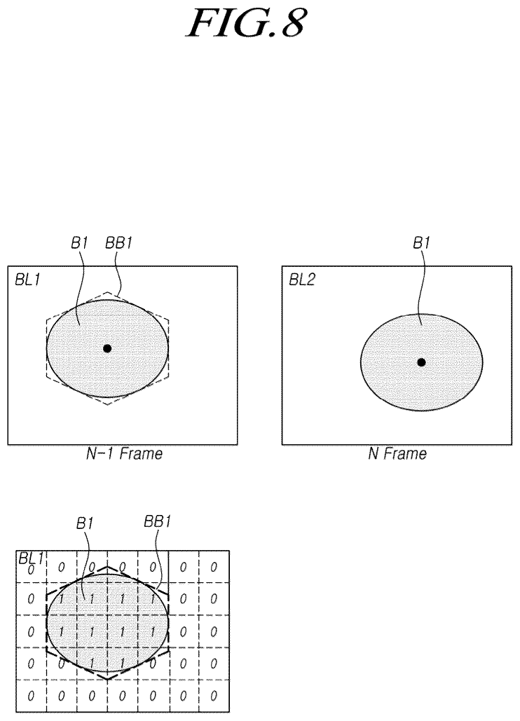

FIG. 8 is a view illustrating an operation of setting different weights for a region of interest corresponding to an object of interest and a background region, according to an embodiment of the disclosure.

FIG. 9 is a view illustrating an operation of sub-sampling an image including an object of interest by a display device according to an embodiment of the disclosure.

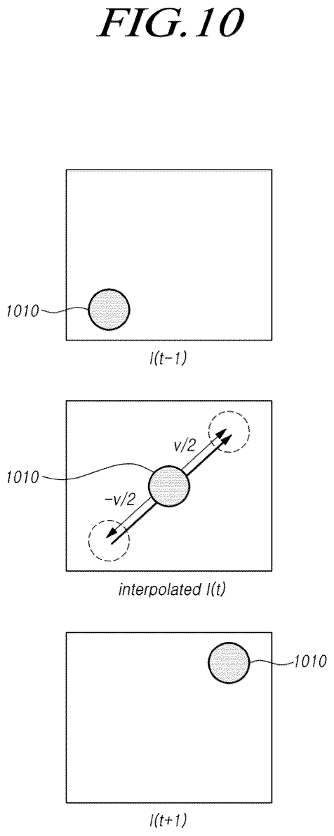

FIG. 10 is a view illustrating an operation of performing motion compensation based on motion information by a display device according to an embodiment of the disclosure.

Referring to FIGS. 5 to 6C, a display device (e.g., at least one of a display device 600A, a display device 600B, and a display device 600C) may obtain output data 602 by performing an operation of detecting an object of interest (e.g., the object of interest 211 of FIG. 2) and/or a shape of the object of interest using input data 601 including at least one frame of an image (e.g., the image 200 of FIG. 2), an operation of estimating a motion based on the shape of the object of interest, and/or an operation of performing motion compensation (or interpolation) based on the motion estimation. The output data 602 may be transferred to at least one other component for image processing. According to embodiments, one or more of the display device 600A, the display device 600B, and the display device 600C may, for example, correspond to the display device 100 of FIG. 1.

According to an embodiment, each of the display devices 600A, 600B, and 600C may include an object detection unit 610, an object shape detection unit 620, a motion estimation unit 630, and/or a motion interpolation unit 640. According to an embodiment, some of the above-described components (e.g., the motion interpolation unit 330) may be omitted, and additional components may be further included. According to an embodiment, a plurality of components among the above-described components may be integrated into one component. For example, the object detection unit 610 and the object shape detection unit 620 may be integrated into one component. In this case, the integrated component may perform an operation for detecting an object of interest in an image and an operation for detecting the shape of the object of interest. For example, the integrated component may perform an operation for object detection for each frame of an image and an operation for shape detection of the object together using one trained artificial intelligence model.

According to an embodiment, the object detection unit 610, the object shape detection unit 620, the motion estimation unit 630, and/or the motion interpolation unit 640 may be implemented using at least one processor (e.g., the processor 110 of FIG. 1). For example, instructions may be stored in memory (e.g., the memory 120 of FIG. 1) and, when executed by at least one processor 110, may cause the display device 100 to perform at least one function and/or operation of the object detection unit 610, the object shape detection unit 620, the motion estimation unit 630, and/or the motion interpolation unit 640.

According to an embodiment, as illustrated in FIG. 6A, the operation of the object detection unit 610 may be performed before the operation of the object shape detection unit 620, but embodiments are not limited thereto. For example, as illustrated in FIGS. 6B and 6C, the operation of the object detection unit 610 may be performed after the operation of the object shape detection unit 620 or, as described above, may be performed together.

According to an embodiment, as illustrated in FIG. 6C, the display device 600C may further include a motion estimator 631 separate from the motion estimation unit 630 for the object of interest. The motion estimator 631 may estimate, e.g., a motion for an object other than the object of interest in a continuous frame. In this case, the motion interpolation unit 640 may increase the accuracy of motion compensation by performing motion compensation using both the motion estimation results of the motion estimation unit 630 and the motion estimator 631.

The operation of at least one of the object detection unit 610, the object shape detection unit 620, the motion estimation unit 630, and/or the motion interpolation unit 640 described above may correspond to one or more of the operations illustrated in FIG. 5.

According to an embodiment, at operation 510 of FIG. 5, the display device 100 may identify or detect an object of interest (e.g., the object of interest 401 of FIG. 4A) (or the shape of the object of interest) included in the first frame (e.g., the N−1 frame of FIG. 4A). Operation 510 may be performed, e.g., by the object detection unit 610 and/or the object shape detection unit 620 of FIGS. 6A to 6C.

According to an embodiment, the operation of identifying the shape of the object of interest may be performed after or before the display device 100 detects the object of interest, or may be performed together with detection of the object of interest. The operation of detecting the object of interest by the display device 100 may be performed by, e.g., the object detection unit 610 of FIGS. 6A to 6C.

Hereinafter, first, an example of an operation of detecting (or identifying) an object of interest in an image by the display device 100 is described. The object of interest may be detected using, e.g., a trained artificial intelligence model and/or edge information of the image, but embodiments are not limited thereto. In the following description, the operation of the display device 100 for detecting the object of interest may correspond to an operation of the object detection unit 610.

According to an embodiment, the display device 100 may detect the object of interest included in the frame using a trained first artificial intelligence model (e.g., the artificial intelligence model 700 of FIG. 7A). For example, as illustrated in FIG. 7A, the display device 100 may input the frame 701 into the trained first artificial intelligence model (e.g., may provide the frame 701 as input to the trained first artificial intelligence model) and obtain output data including object-of-interest detection information about at least one object of interest (e.g., a first ball B1 and/or a second ball B2) included in the frame from the first artificial intelligence model.

According to an embodiment, the object-of-interest detection information may include, e.g., type information about the type of the object of interest, sub type information about the sub type of the object of interest, and/or confidence information about the confidence of the object of interest (e.g., at least one of a confidence, a confidence level, and a confidence value corresponding or associated with the object of interest). For example, as shown in the example of the block BL6 illustrated in FIG. 7B, the first object-of-interest detection information about the first ball B1 of FIG. 7A may include type information indicating that the type of the object of interest is a ball (e.g., “Ball”), sub type information indicating that the sub type of the object of interest is a baseball (e.g., “Type1”), and/or confidence information indicating that the confidence of the object of interest (e.g., a confidence level associated with the object of interest) is 95% (e.g., “Probability 0.95”). The display device 100 may identify (or, determine) that the baseball is included in the frame at a 95% confidence level using the first object-of-interest information. For example, as shown in the example of the block BL1 illustrated in FIG. 7B, the second object-of-interest detection information about the second ball B2 of FIG. 7A may include type information indicating that the type of the object of interest is a ball (e.g., “Ball”), sub type information indicating that the sub type of the object of interest is a rugby ball (e.g., “Type2”), and/or confidence information indicating that the confidence of the object of interest (e.g., a confidence level associated with the object of interest) is 85% (e.g., “Probability 0.85”). The display device 100 may identify that the rugby ball is included in the frame at an 85% confidence level using the second object-of-interest information. According to an embodiment, the type information and the sub type information may be integrated into one piece of information. When detecting an object of interest by obtaining the object-of-interest detection information about the object of interest through the trained first artificial intelligence model as such, the object of interest may be detected quickly and accurately compared to other approaches (e.g., an approach which uses edge information).

According to an embodiment, the first artificial intelligence model may be a convolutional natural network (CNN) model or a region-based CNN (R-CNN) model, but embodiments are not limited thereto. The first artificial intelligence model may be trained using a specified training scheme. The specified training scheme may be, e.g., at least one of a supervised training scheme, a non-supervised training scheme, or a reinforcement training scheme. For example, based on the supervised training scheme being used, the first artificial intelligence model may be trained based on training data including frames including at least one labeled object of interest. For example, a frame including a baseball (e.g., the first ball B1) as an object of interest may be labeled with first data including a ball (type), a baseball (sub type), and/or a probability value of 1 (which may correspond to a confidence level of 100%).

According to an embodiment, the display device 100 may detect the object of interest included in the frame using edge information. The edge may refer to, e.g., a portion of the image (or frame) in which the pixel value (or brightness) changes rapidly, and may be used as information indicating the outline or boundary of the object.

According to an embodiment, the display device 100 may obtain the edge information by detecting the edge in the frame using a specified edge detection algorithm. The specified edge detection algorithm is an algorithm that detects the edge based on a difference in brightness between pixels of the frame, and may be, e.g., at least one of a Sobel algorithm, a Prewitt algorithm, or a Canny algorithm. The display device 100 may extract the boundary line of the object based on the edge information, and identify or determine whether the object of interest is present in the frame using the extracted boundary line. For example, the display device 100 may determine whether the object of interest is present in the frame by determining whether the extracted boundary line matches a predetermined characteristic (e.g., pattern, size, and shape) of the object of interest. Based on determining that the object of interest is present in the frame, the display device 100 may obtain the location information (e.g., location coordinates) of the object of interest in the frame. Using this process, the display device 100 may detect the object of interest included in the frame.

Hereinafter, an example of an operation of detecting (or identifying) a shape of an object of interest in an image by the display device 100 is described. The shape of the object of interest may be detected using, e.g., a trained artificial intelligence model and/or edge information of the image, but embodiments are not limited thereto. In the following description, the operation of the display device 100 for detecting the shape of the object of interest may correspond to an the operation of the object shape detection unit 620.

According to an embodiment, the display device 100 may detect (or identify) the shape of the object of interest included in the frame using a trained second artificial intelligence model (e.g., the artificial intelligence model 700 of FIG. 7A). For example, as illustrated in FIG. 7A, the display device 100 may input the frame 701 into the trained second artificial intelligence model and obtain output data including object-of-interest shape information about the shape of the object of interest for at least one object of interest (e.g., the first ball B1 and/or the second ball B2) from the second artificial intelligence model.

According to an embodiment, the object-of-interest shape information may include information about the shape of the corresponding object of interest. The information about the shape of the object of interest may include, e.g., information about the region (hereinafter, referred to as a region of interest) corresponding to the shape of the object of interest. For example, the first object-of-interest shape information about the first ball B1 of FIG. 7A may include information indicating that the region of interest corresponding to the shape of the object of interest is a first region (e.g., “Area 1”), as shown in the example of the block BL6 illustrated in FIG. 7B. For example, the second object-of-interest shape information about the second ball B2 of FIG. 7B may include information indicating that the region of interest corresponding to the shape of the object of interest is a second region (e.g., “Area 2”), as shown in the example of the block BL1 illustrated in FIG. 7B. Accordingly, the display device 100 may identify the region of interest occupied by the object of interest in the frame (or a specific block of the frame). The region of interest may be, e.g., a region corresponding to a bounding box (e.g., the first bounding box BB1 and the second bounding box BB2 of FIG. 7A) surrounding the object of interest. In this case, the information about the region of interest corresponding to the shape of the object of interest may include location coordinates indicating the location of the corresponding bounding box in the frame. The setting for the shape (e.g., rectangle, polygon) of the bounding box may be variously set according to the type of the object of interest, a required delay time, and the performance of the processor. For example, as the performance of the processor increases, the bounding box may be set to further fit the boundary of the object of interest, so that the region of interest may be more accurately identified.

According to an embodiment, the second artificial intelligence model may be a CNN model or an R-CNN model, but embodiments are not limited thereto. The second artificial intelligence model may be trained using a specified training scheme. The specified training scheme may be, e.g., a supervised training scheme, a non-supervised training scheme, or a reinforcement training scheme. For example, based on the supervised training scheme being used, the second artificial intelligence model may be trained based on training data including frames including at least one labeled object of interest. For example, a frame including a baseball (e.g., the first ball B1) as an object of interest may be labeled with second data including a region (e.g., “Area 1”) corresponding to the baseball.

According to an embodiment, the display device 100 may detect the shape of the object of interest included in the frame using edge information. The display device 100 may extract the boundary line of the object based on the edge information and generate a closed curve of the object by connecting consecutive boundary lines. The display device 100 may identify the shape of the object of interest using the generated closed curve. The process for detecting the shape of the object of interest using such edge information may exhibit somewhat low performance as compared with the process for detecting the shape of the object of interest using the trained artificial intelligence model due to the complexity of the background, the complexity of the shape of the object, and influence of noise.

According to an embodiment, detection of the object of interest and detection of the shape of the object of interest may be performed together or simultaneously. For example, the display device 100 may use one integrated artificial intelligence model (which may be referred to as a third artificial intelligence model) to perform detection of the object of interest for the frame and detection of the shape of the object of interest together. In this case, as illustrated in FIG. 7A, the display device 100 may input the frame 701 to the trained third artificial intelligence model and obtain output data including both object-of-interest detection information and object-of-interest shape information about at least one object of interest (e.g., the first ball B1 and/or the second ball B2) from the third artificial intelligence model. For example, as shown in the example of the block BL6 illustrated in FIG. 7B, the first output data for the first ball B1 of FIG. 7A may include first object-of-interest detection information including type information indicating that the type of the object of interest is a ball, sub type information indicating that the sub type of the object of interest is a baseball, and/or confidence information indicating that the confidence of the object of interest is 95%, and first object-of-interest shape information indicating that the region of interest corresponding to the shape of the object of interest is the first region (e.g., “Area 1”). Accordingly, the display device 100 may identify that the baseball is included in the first region at a 95% confidence level in the frame. For example, as shown in the example of the block BL1 illustrated in FIG. 7B, the second output data for the second ball B2 of FIG. 7A may include second object-of-interest detection information including type information indicating that the type of the object of interest is a ball, sub type information indicating that the sub type of the object of interest is a rugby ball, and/or confidence information indicating that the confidence of the object of interest is 85%, and second object-of-interest shape information indicating that the region of interest corresponding to the shape of the object of interest is the second region (e.g., “Area 2”). The display device 100 may identify that the rugby ball is included in the second region at an 85% confidence level in the frame.

According to an embodiment, the third artificial intelligence model may be a CNN model or an R-CNN model, but embodiments are not limited thereto. The third artificial intelligence model may be trained using a specified training scheme. The specified training scheme may be, e.g., a supervised training scheme, a non-supervised training scheme, or a reinforcement training scheme. For example, based on the supervised training scheme being used, the third artificial intelligence model may be trained based on training data including frames including at least one labeled object of interest. For example, a frame including a baseball (e.g., the first ball B1) as an object of interest may be labeled with third data including a ball (type), a baseball (sub type), a region (Area 1) corresponding to the baseball, and/or a probability value of 1 (which may correspond to a confidence level of 100%).

At operation 520, the display device 100 may obtain motion information (e.g., motion vector) representing (or, indicating) the motion of the object of interest between the first frame (e.g., the “N−1 frame” of FIG. 4A) and the second frame (e.g., the “N frame” of FIG. 4A) based on the shape of the object of interest. The first frame and the second frame may be consecutive frames. For example, the second frame may be a frame immediately following the first frame. Operation 520 may be performed, e.g., by the motion estimation unit 630 of FIGS. 6A to 6C.

According to an embodiment, obtaining the motion information in operation 520 may include setting different weights for a region of interest corresponding to the shape of the object of interest and a background region other than the region of interest. For example, obtaining the motion information in operation 520 may include setting a plurality of weights, including a first weight associated with a region of interest corresponding to the shape of the object of interest, and a second weight associated with background region other than the region of interest, and the first weight may be different from the second weight. For example, the display device 100 may set a first weight value for pixels (e.g., a first plurality of pixels) included in the region of interest and set a second weight value for pixels (e.g., a first plurality of pixels) included in the background region. The first weight value may be larger than the second weight value. According to an embodiment, the region of interest and the background region may be included in one block.

According to an embodiment, obtaining the motion information in operation 520 may be performed using a block matching algorithm according to a specified similarity measurement scheme. The block matching algorithm may be an algorithm that determines a block (which may be referred to as a matching block) that matches the reference block to be the most similar block, for example by comparing the reference block (e.g., a block of interest) of the reference frame and the search blocks (e.g., candidate search blocks) of the search frame using the specified similarity measurement scheme. For example, obtaining the motion information in operation 520 may include identifying or selecting the matching block that matches the reference block (e.g., a block that includes the object of interest in the first frame) from among a plurality of candidate search blocks of the second frame using the block matching algorithm according the specified similarity measurement scheme, and obtaining the motion information about the object of interest based on the reference block and the matching block. The operation of identifying the matching block may include an operation of measuring the similarity between the reference block and each candidate search block (e.g., measuring the SAD value) from among the plurality of candidate search blocks using a specified similarity measurement scheme (e.g., SAD scheme) based on the set first weight value and the set second weight value.

According to an embodiment, the specified similarity measurement scheme used for the block matching algorithm may include, e.g., an SAD scheme, a sum of squared differences (SSD) scheme, and a mean squared error (MSE) scheme. The SAD scheme may be, e.g., a scheme of converting a difference in pixel value between two blocks into an absolute value and then accumulating the same for all the pixels. The SSD scheme may be, e.g., a scheme of squaring the difference in pixel value between two blocks and then accumulating the same for all the pixels. The MSE scheme is a scheme of obtaining an average value of SSDs, and may show an average difference between blocks. Hereinafter, for convenience of description, an example is described in which the specified similarity measurement scheme is the SAD scheme, but embodiments are not limited thereto.

In general, the SAD scheme corresponds to a scheme of measuring the similarity between two blocks using Equation 1 below. The SAD scheme using Equation 1 may be used, e.g., by the motion estimation unit 320 of FIG. 3.

$$SAD ( k ) = {\sum }_{i = 0}^{m - 1} {\sum }_{j = 0}^{n - 1} \vert Pre ( i , j ) - Cur ( i , j ) \vert \qquad [ Equation 1 ]$$

Here, Pre(i,j) may denote the pixel value corresponding to the locations (i,j) in the reference block of the reference frame (previous frame) (e.g., the “N−1 frame” of FIG. 4A) Cur(i,j) may denote the pixel value corresponding to the location (i,j) in the search block of the search frame (e.g., a current frame) (e.g., the “N frame” of FIG. 4A), m may denote the vertical size of the two blocks to be compared, n may denote the horizontal size of the two blocks to be compared, and k may denote the index of the search block to be compared with the reference block. A different index may be allocated to each search block (e.g., each candidate block) identified based on a specified search range (e.g., −HSR˜+HSR, −VSR˜+VSR), where HSR denotes a horizontal search range and VSR denotes a vertical search range, within a specified search region (e.g., the search region 430 of FIG. 4A).

According to an embodiment, the display device 100 may calculate the SAD value between the reference block including the object of interest and each search block (e.g., each candidate block) in the search region using Equation 1, and identify the search block corresponding to the index k having the smallest SAD value as the matching block that is most similar to the reference block, (e.g., the block that the best matched with the reference block). According to embodiments, the SAD value may also be referred to as a similarity measurement value.

However, because the SAD scheme using Equation 1 does not consider the shape of the object of interest, the similarity between the two blocks may not be accurately measured due to factors such as complexity of the background, complexity of the shape of the object of interest, and influence of noise. Therefore, Equation 2 below using weight information considering the shape of the object of interest may be used for the SAD scheme. The SAD scheme using Equation 2 may be used, e.g., by the motion estimation unit 630 of FIGS. 6A to 6C. According to embodiments, the SAD scheme using Equation 2 may be referred to as an enhanced SAD scheme and a modified SAD scheme.

$$SAD ( k ) = {\sum }_{i = 0}^{m - 1} {\sum }_{j = 0}^{n - 1} wgt ( i , j ) * \vert Pre ( i , j ) - Cur ( i , j ) \vert \qquad [ Equation 2 ]$$

Here, Pre(i,j) may denote the pixel value corresponding to the locations (i,j) in the reference block of the reference frame (previous frame) (e.g., the “N−1 frame” of FIG. 4A), Cur(i,j) may denote the pixel value corresponding to the location (i,j) in the search block of the search frame (e.g., the current frame) (e.g., the “N frame” of FIG. 4A), wgt(i,j) may denote the weight value of the pixel corresponding to the location (i,j). The weight value may be set to a value between 0 and 1, for example. In addition, m may denote the vertical size of the two blocks to be compared, n may denote the horizontal size of the two blocks to be compared, and k may denote the index of the search block to be compared with the reference block. A different index may be allocated to each search block (e.g., each candidate block) identified based on a specified search range (e.g., −HSR˜+HSR, −VSR˜+VSR) within a specified search region (e.g., the search region 430 of FIG. 4A).

According to an embodiment, the display device 100 may calculate the SAD value between the reference block including the object of interest and each search block (e.g., each candidate block) in the search region using Equation 2, and identify the search block corresponding to the index k having the smallest SAD value as the matching block that is most similar to the reference block, (e.g., the block that is the best matched to the reference block). According to embodiments, the SAD value may be referred to as a similarity measurement value.

According to an embodiment, based on the pixel corresponding to the location (i,j) in the corresponding block (e.g., reference block, search block) being included in the region of interest (e.g., the region corresponding to the bounding box BB1 of FIG. 8) of the object of interest (e.g., the ball B1 of FIG. 8), the display device 100 may set the weight value wgt(i,j) of the corresponding pixel as a first value and, based on the pixel corresponding to the location (i,j) being included in the background region other than the region of interest, set the weight value wgt(i,j) of the corresponding pixel as a second value. The first value (e.g., 1) may be set to a value higher than the second value (e.g., 0). Accordingly, different weight values may be applied to the region of interest corresponding to the object of interest (or the shape of the object of interest) and the background region other than the region of interest. For example, a higher weight value may be set for the region of interest than the background region, so that the similarity measurement using the SAD scheme may be performed considering the shape of the object of interest. Therefore, this similarity measurement scheme may reflect the characteristics of the shape of the object of interest and may remove or reduce errors caused by the background other than the object of interest, enabling accurate measurement of similarity between the two blocks. Accordingly, it may be possible to more accurately discover a matching block including the object of interest in the search region.

According to an embodiment, based on the size of the overlap between the region of the pixel corresponding to the location (i,j) and the region of interest of the object of interest being a specified size (e.g., equal to or more than half the size of the pixel region), the display device 100 may determine that the pixel corresponding to the location (i,j) is included in the region of interest of the object of interest. Otherwise, it may be determined that the pixel corresponding to the location (i,j) is not included in the region of interest of the object of interest.

Accordingly, even when only a portion of the region of the pixel, rather than the entire pixel region, is included in the region of interest, an appropriate weight may be set for the corresponding pixel considering the exact shape of the object of interest.

According to an embodiment, identifying the shape of the object of interest at operation 510 and/or obtaining the motion information in operation 520 may include an operation of performing sub-sampling on an image including the object of interest. Sub-sampling may be performed, e.g., to include the object of interest in one block. For example, because the object of interest B1 is illustrated at a lower side of FIG. 9, the object of interest B1 may be located across a plurality of blocks BL1a to BL1d. In this case, based on a block matching algorithm being performed to obtain the motion information, it may be difficult to clearly specify the reference block including the object of interest in the reference frame (e.g., the “N−1 frame” of FIG. 4A), which may make accurate block matching difficult to perform. To address this issue, the display device 100 may perform sub-sampling on the image to reduce the resolution of the image (or frame). For example, the display device 100 may sub-sample the original image with a 4K resolution (3840×2160) to convert the original image into an image with a full high definition (FHD) resolution (1920×1080). In this case, e.g., as illustrated at the upper side of FIG. 9, the object of interest B1 may be included in one block BL1. The display device 100 may perform the above-described block matching algorithm using the sub-sampled image. Accordingly, accurate block matching may be performed.

According to an embodiment, obtaining the motion information at operation 520 may include an operation of obtaining a motion vector for the object of interest based on a block (matching block) of the second frame (e.g., the matching block 420 of FIG. 4A) that matches the reference block (e.g., the reference block 410 of FIG. 4A) including the object of interest of the first frame. The motion vector may indicate the direction and size in which the reference block including the object of interest of the first frame moves in the second frame. For example, based on determining that the location coordinates of the reference block of the first frame are (50, 30) and the location coordinates of the matching block of the second frame matching the reference block identified through the block matching algorithm are (55,35), the motion vector may be V=(55-50, 35-30)=(5,5).

At operation 530, the display device 100 may perform motion compensation based on the motion information. For example, the display device 100 may add a motion compensation frame between the first frame and the second frame based on the motion information. According to embodiments, the motion compensation frame may be referred to as an interpolation frame. Operation 530 may be performed, e.g., by the motion interpolation unit 640 of FIGS. 6A to 6C.

According to an embodiment, as illustrated in FIG. 10, the display device 100 may generate a motion compensation frame (e.g., an interpolation frame) (e.g., the “I(t)” frame of FIG. 10) between the first frame (e.g., the “I(t−1)” frame of FIG. 10) and the second frame (e.g., the “I(t+1)” frame of FIG. 10) by performing motion compensation based on the motion information about the object of interest 1010. For example, the display device 100 may generate the interpolation frame between the first frame and the second frame based on the motion information using a specified interpolation scheme. The specified interpolation scheme may include, but is not limited to, a linear interpolation process, a polynomial interpolation scheme, a non-linear interpolation scheme, a Gaussian interpolation scheme, and a nearest-neighbor interpolation scheme. As an example, the linear interpolation scheme may be performed using Equation 3 below.

$$I ( x , t ) = ω I ( x - v / 2 , t - I ) + ( 1 - ω ) I ( x + v / 2 , t + 1 ) \qquad [ Equation 3 ]$$

Here, I(x,t) may denote the pixel value at location x at time t, v may denote motion vector, w may denote a weighting factor used to adjust the contribution of the previous frame (e.g., the “I(t−1)” frame of FIG. 10) and the next frame (e.g., the “I(t+1)” of FIG. 10) during interpolation, and having a value between 0 and 1.

In addition, I(x−v/2, t−1) may denote the pixel value at the location of x−v/2 at time t−1, corresponding to the value calculated by reflecting the motion vector in the previous frame. Further, I(x+v/2, t+1) may denote the pixel value at the location of x+v/2 at time t+1, corresponding to the value calculated by reflecting the motion vector at the next frame.

According to an embodiment, the display device 100 may interpolate the pixel value of the intermediate frame (interpolation frame) (e.g., the “I(t)” frame of FIG. 10) based on the temporal change between the previous frame (e.g., the “I(t−1)” frame of FIG. 10) and the next frame (e.g., the “I(t+1)” frame of FIG. 10), which are consecutive frames, using Equation 3. For example, the display device 100 may estimate an intermediate pixel value according to the motion vector v value based on the pixel values of the previous frame and the next frame.

According to an embodiment, motion compensation based on the motion information may be used to perform frame rate conversion (FRC), motion compensated interpolation (MIC), or motion judder cancellation (MJC). The frame rate conversion may be a technology for converting the frame rate to match the image in the display device 100 having a frame rate different from the frame rate of the original image. For example, the frame rate conversion may include raising the frame rate to match the 24 frames per second (fps) image to a 60 fps high-frame display. The motion compensated interpolation may be a technology that calculates the motion vector and interpolates an intermediate frame based thereon to increase the frame rate to provide a smoother motion. For example, the motion compensated interpolation may include converting a 30 fps image into a 60 fps image by adding a new frame between existing frames based on the motion vector. The motion judder cancellation may be a technology that enables smooth image reproduction by removing motion judder caused by a mismatch between the frame rate and the display scan rate.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, expressions such as “at least one of,” when preceding a list of elements, modify the entire list of elements and do not modify the individual elements of the list. For example, the expressions “at least one of A, B, and C” and “at least one of A, B, or C” may be understood as including only A, only B, only C, both A and B, both A and C, both B and C, or all of A, B, and C.

As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software including one or more instructions that are stored in a storage medium readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a process according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of a server associated with the manufacturer, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A display device, comprising:
a display;
at least one processor comprising processing circuitry; and
memory comprising at least one storage medium storing one or more instructions which, when executed by the at least one processor, cause the display device to: detect an object of interest included in a first frame of an image;
obtain motion information representing a motion of the object of interest between the first frame and a second frame based on a shape of the object of interest; and
add a motion compensation frame between the first frame and the second frame based on the motion information,
wherein to obtain the motion information, the one or more instructions, when executed by the at least one processor, further cause the display device to: set a plurality of weights comprising a first weight associated with a region of interest corresponding to the object of interest, and a second weight associated with a background region different from the region of interest, wherein the second weight is different from the first weight, and
wherein the plurality of weights are used to select a matching block that matches a reference block including the object of interest, from among a plurality of candidate search blocks of the second frame, and
wherein the reference block and the matching block are used to obtain the motion information.

2. The display device of claim 1, wherein to set the plurality of weights, the one or more instructions, when executed by the at least one processor, further cause the display device to: set a first weight value for a first plurality of pixels included in the region of interest, and set a second weight value for a second plurality of pixels included in the background region, and
wherein the first weight value is larger than the second weight value.

3. The display device of claim 2, wherein to obtain the motion information, the one or more instructions, when executed by the at least one processor, further cause the display device to:
select the matching block using a block matching algorithm according to a specified similarity measurement scheme; and
obtain the motion information based on the reference block and the matching block.

4. The display device of claim 3, wherein to select the matching block, the one or more instructions, when executed by the at least one processor, further cause the display device to:
measure a similarity between the reference block and each candidate search block from among the plurality of candidate search blocks using the specified similarity measurement scheme based on the first weight and the second weight value.

5. The display device of claim 4, wherein the specified similarity measurement scheme corresponds to a sum of squared differences (SAD) scheme, and
wherein the SAD scheme is performed using the a following equation:
$$SAD ( k ) = {\sum }_{i = 0}^{m - 1} {\sum }_{j = 0}^{n - 1} wgt ( i , j ) * \vert Pre ( i , j ) - Cur ( i , j ) \vert$$
where Pre(i,j) denotes a pixel value corresponding to a position (i,j) in the reference block of the first frame, Cur(i,j) denotes a pixel value corresponding to the position (i,j) in a candidate search block from among the plurality of candidate search blocks, wgt(i,j) denotes a weight value of a pixel corresponding to the position (i,j), m denotes a vertical size of the candidate search block, n denotes a horizontal size of the candidate search block, and k denotes an index of the candidate search block.

6. The display device of claim 1, wherein to identify the shape of the object of interest, the one or more instructions, when executed by the at least one processor, further cause the display device to: obtain information about the shape of the object of interest using a trained artificial intelligence model, and
wherein the trained artificial intelligence model is trained to output output data comprising information about the shape of the object of interest based on an input frame.

7. The display device of claim 6, wherein the output data further comprises object-of-interest detection information, and
wherein the object-of-interest detection information comprises at least one of type information about a type of the object of interest, sub type information about a sub type of the object of interest, or confidence information about a confidence level associated with the object of interest.

8. The display device of claim 6, wherein to identify the shape of the object of interest, the one or more instructions, when executed by the at least one processor, further cause the display device to: sub-sample the image at a specified ratio such that the object of interest is included in one block.

9. The display device of claim 1, wherein the first frame is consecutive with the second frame,
wherein the motion information corresponds to a motion vector for the object of interest, and
wherein the motion compensation frame is generated based on the motion vector.

10. The display device of claim 9, wherein the motion compensation frame is used to perform at least one from among frame rate conversion, motion compensated interpolation, or motion judder cancellation.

11. A method of controlling a display device, the method comprising:
detecting an object of interest included in a first frame of an image;
obtaining motion information representing a motion of the object of interest between the first frame and a second frame based on a shape of the object of interest; and
adding a motion compensation frame between the first frame and the second frame based on the motion information,
wherein the obtaining of the motion information comprises: setting a plurality of weights comprising a first weight associated with a region of interest corresponding to the object of interest, and a second weight associated with a background region other than the region of interest, wherein the second weight is different from the first weight,
wherein the plurality of weights are used to select a matching block that matches a reference block including the object of interest, from among a plurality of candidate search blocks of the second frame, and
wherein the reference block and the matching block are used to obtain the motion information.

12. The method of claim 11, wherein the setting of the plurality of weights comprises:
setting a first weight value for a first plurality of pixels included in the region of interest, and
setting a second weight value for a second plurality of pixels included in the background region, and
wherein the first weight value is larger than the second weight value.

13. The method of claim 11, wherein the obtaining of the motion information comprises:
selecting the matching block using a block matching algorithm according to a specified similarity measurement scheme; and
obtaining the motion information based on the reference block and the matching block.

14. The method of claim 13, wherein the selecting of the matching block comprises:
measuring a similarity between the reference block and each candidate search block from among the plurality of candidate search blocks using the specified similarity measurement scheme based on the first weight value and the second weight value.

15. The method of claim 14, wherein the specified similarity measurement scheme corresponds to a sum of squared differences (SAD) scheme, and
wherein the SAD scheme is performed using a following equation:
$$SAD ( k ) = {\sum }_{i = 0}^{m - 1} {\sum }_{j = 0}^{n - 1} wgt ( i , j ) * \vert Pre ( i , j ) - Cur ( i , j ) \vert$$
where Pre(i,j) denotes a pixel value corresponding to a position (i,j) in the reference block of the first frame, Cur(i,j) denotes a pixel value corresponding to the position (i,j) in the candidate search block from among the plurality of candidate search blocks, wgt(i,j) denotes a weight value of a pixel corresponding to the position (i,j), m denotes a vertical size of the candidate search block, n denotes a horizontal size of the candidate search block, and k denotes an index of the candidate search block.

16. The method of claim 11, wherein identifying the shape of the object of interest comprises:
obtaining information about the shape of the object of interest using a trained artificial intelligence model, and
wherein the trained artificial intelligence model is trained to output output data comprising information about the shape of the object of interest based on an input frame.

17. The method of claim 16, wherein the output data further includes object-of-interest detection information, and
wherein the object-of-interest detection information comprises at least one of type information about a type of the object of interest, sub type information about a sub type of the object of interest, or confidence information about a confidence level associated with the object of interest.

18. The method of claim 16, wherein the identifying of the shape of the object of interest comprises:
sub-sampling the image at a specified ratio such that the object of interest is included in one block.

19. The method of claim 11, wherein the first frame is consecutive with the second frame,
wherein the motion information corresponds to a motion vector for the object of interest, and
wherein the motion compensation frame is generated based on the motion vector.

20. The method of claim 19, wherein the motion compensation frame is used to perform at least one from among frame rate conversion, motion compensated interpolation, or motion judder cancellation.
